(19) United States
(12) Patent Application Publication
(10) Pub. No.: US 2007/0184216 A1
(43) Pub. Date: Aug. 9, 2007

(54) Gels of polysaccharide, fluorinated surfactant and particles

(75) Inventor: Didier J. Martin, Givry (FR)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/348,672

(22) Filed: Feb. 7, 2006

(51) Int. Cl. B41M 5/00

(52) U.S. Cl. 428/32.1

(57) ABSTRACT

The present invention relates to an image receiver element comprising a support having on at least one surface thereof a porous absorbent coating layer comprising an inorganic colloidal particulate material, having a negatively charged surface, in a binder matrix, wherein the binder matrix comprises a hydrophilic gelator, a fluorinated compound, and at least one polymer comprising hydroxyl groups. The present invention also relates to a receiver for inkjet printing comprising a support having on at least one surface thereof a porous absorbent coating comprising a colloidal particulate material, having a negatively charged surface, in a binder matrix, wherein the binder matrix comprises a hydrophilic gelator, guar gum, a fluorinated compound, and polyvinyl alcohol. Carrageenan is the most preferred thermoreversible hydrophilic gelator.

### CROSS REFERENCE TO RELATED APPLICATIONS

Reference is made to commonly assigned, co-pending U.S. patent applications:

Ser. No.______by Didier Martin (Docket 86917) filed of even date herewith entitled “MATERIAL FOR FORMING IMAGES BY INKJET PRINTING”;

Ser. No.______by Didier Martin (Docket 86918) filed of even date herewith entitled “MATERIAL FOR FORMING IMAGES BY INKJET PRINTING”;

Ser. No.______by Didier Martin (Docket 88478) filed of even date herewith entitled “COATING METHOD OF MATERIAL FOR INKJET PRINTING”; and

Ser. No.______by Didier Martin (Docket 88479) filed of even date herewith entitled “POLYSACCHARIDE MATERIALS WITH HYDROXYLATED POLYMERS IN INK RECEIVING MEDIA”, the disclosures of which are incorporated herein by reference.

### FIELD OF THE INVENTION

The present invention relates to a polymeric material based on polysaccharides in combination with fluorinated surfactant and negatively charged inorganic porous particles to form gels for image receiving layers.

### BACKGROUND OF THE INVENTION

Some of the most common water soluble polymers for swellable inkjet media are gelatin, PVA, PVP, and poly(ethyleneoxide), and their mixtures. Blending two or more of these polymers is commonly done, but compatibility problems are frequently encountered. Incompatibility results in poor coating and image quality.

Out of all these water soluble polymers, only gelatin and PVA are crosslinkable. Because of this lack of crosslinkability, the polymers have poor waterfastness. Specific disadvantages of PVP can include, but are not limited to, tackiness, poor light fastness, poor smudge resistance, and poor fingerprint resistance. Specific disadvantages of PVA include, but are not limited to, poor image quality, poor drying, poor coalescence and a poor ink absorption rate.

In general, to form a film or coating on a flexible support, a solution containing the desired film material is coated onto the support and dried. For high productivity and lower costs, these coatings are applied to continuous webs at high speeds and dried in an oven. Because of air impingement during drying and artifacts from the actual coating application method, coating defects may occur, for example, non-uniformity in thickness and streaks. For applications that require a high degree of coating uniformity, such as high quality photographic media and inkjet media, this problem may be solved by using coating solution that contain a thermoreversible gelling material such as gelatin. After applying the thermoreversible gelling solution to the web, the coating is then cooled to gel the coating. Very few materials are available that undergo thermoreversible gelling. Furthermore, the use of swelling material (gelatin) for inkjet media does not achieve high performance in terms of dry ink fastness.

Another solution to the problem of coating a web support is to use shear-thinning solutions. These solutions have a low viscosity at high shear rates. Because of the high viscosity at low shear rates, it is often difficult preparing and delivering these solutions to the coating, sometimes requiring additional manufacturing expense. Furthermore, the increased viscosity does not allow high coating speed and the use of coating machine equipped with classical drying loops.

U.S. Pat. No. 4,898,810 discloses the use of gelatin plus Gellan gum to provide improved setting property. For this invention, the main binder is the gelatin material and the main drawbacks of gelatin material for inkjet application are maintained in terms of curl propensity, and swelling propensity. Furthermore, gellan gum, such as Gelrite™ supplied by KELCO or MERCK, when compared to the present inventive use of carrageenan, does not provide gel formation even at 0.5% weight content and even with polyvinyl alcohol. To achieve gel formation at such content, the addition of salt, that is, sodium chloride at 0.1%, is required and provides a soft and brittle gel. In addition, Gelrite™ is not easily dissolved in water and the presence of insoluble materials is observed and cannot be easily isolated by simple filtration due to plugging of filtration material).

Imaging Science Journal, 2000, 48, p 193-198 discloses the sol-gel transition of a mixture of gelatin and K-carrageenan. The publication describes the gel formation from gelatin and carrageenan-K through rheology studies where gelatin is the main binder. The publication does not mention the combination of carrageenan and polyvinyl alcohol.

EP1020300 describes an inkjet media prepared from a water based formulation of polyvinyl alcohol, polyvinyl pyrrolidone, latex and inorganic materials. No gelator material is described therein.

U.S. Pat. No. 6,419,987 discloses a method for providing a high viscosity coating on a moving web and articles made thereby through the use of an association of curing agents (boric acid and dihydroxy dioxane) and polyvinyl alcohol (PVA) for inkjet media application. The main drawbacks of the association of hardening compounds, that is DHD or borax, with polyvinyl alcohol are related to the cracking propensity and mottle coating defects encountered through the drying process required to manufacture inkjet receiver media. Furthermore, the hardening agents can induce side reactions resulting in yellowish stain as a function of the inkjet media ageing. These hardening agents can diffuse to the surface of the inkjet media and modifying the ink absorption properties by inducing trough curing reactions modifying the swelling and material porosity.

JP97104161 A discloses a recording transparent sheet utilizing xanthan gum on plastic sheet to produce recording media for inkjet application based on aqueous ink. JP97104162A discloses a recording transparent sheet utilizing xanthan gum on plastic sheet to produce recording media exhibiting two layers containing xanthan gum for inkjet application based on aqueous ink. Xanthan gum is well known as an efficient thickner but it does not provides gel formation. The main drawback of the Xanthan gum is related to the drastic viscosity boost that it induces, even at low content. Both patents do not mention any association with polyvinyl alcohol or guar gum. Furthermore, xanthan gum provides poor gloss and poor instant dryness property.

### Problem to be Solved

Thus a need exists for an improved method for manufacturing and coating imaging or printing media, wherein coating defects are reduced or eliminated in the coated film and high coating rates are facilitated.

### SUMMARY OF THE INVENTION

The present invention relates to an image receiver element comprising a support having on at least one surface thereof a porous absorbent coating layer comprising an inorganic colloidal particulate material, having a negatively charged surface, in a binder matrix, wherein the binder matrix comprises a hydrophilic gelator, a fluorinated compound, and at least one polymer comprising hydroxyl groups. The present invention also relates to a receiver for inkjet printing comprising a support having on at least one surface thereof a porous absorbent coating comprising a colloidal particulate material, having a negatively charged surface, in a binder matrix, wherein the binder matrix comprises a hydrophilic gelator, guar gum, a fluorinated compound, and polyvinyl alcohol.

### Advantageous Effect of the Invention

The present invention includes several advantages, not all of which are incorporated in a single embodiment. The invention based on new binder system exhibits good chill setting properties and good gel formation, allowing the use of classical coater machinery equipped with classical loop dryer. Furthermore, this new binder system provides good image preservation by reducing degradation from light or ozone. This system provides good printing performance, including ink drying fastness, and no ink coalescence or spreading for various inkjet printers (dyed inks, pigmented inks), can be coated on various support type, for example, estar and resin-coated paper, and can provide transparent inkjet media with good mechanical properties. The receiver medium has a satin to a glossy finish surface and high ink absorption, resulting in a surface that is almost immediately dry to the touch

### DETAILED DESCRIPTION OF THE INVENTION

The present invention relates to a receiver in the form of a porous absorbent coating, particularly for inkjet printing, comprising a support having on at least one surface thereof a porous hydrophilic absorbent coating comprising a negatively charged inorganic colloidal particulate material in a binder matrix, wherein the binder matrix comprises a hydrophilic gelator, a fluorinated compound, and polymer comprising hydroxyl groups, preferably, a combination of guar gum and polyvinyl alcohol. In the most preferred embodiment, the negatively charged inorganic colloidal particulate material is silica.

The imaging layer may be used to form a coating on a continuous web for use in making imaging or printing media, including inkjet media. The coated layer has improved film homogeneity through the control of the material viscosity and setting property of the material, when cooled immediately after the coating point.

The invention answers multiple challenges in terms of fast ink absorption properties to promote high image sharpness for low particles (pigment, latex) content with good image preservation for a low manufacturing cost. This system provides good printing performances: ink drying fastness, no ink coalescence or spreading for various inkjet printers (dyed inks, pigmented inks) and good image stability. The invention provides inkjet media with good mechanical properties (no curl propensity, good adhesion, no cracking propensity). The invention demonstrates the ability to form materials for ink-jet application based on carrageenan compounds in combination with polyvinyl alcohol and porosity generators (inorganic pigments, latex). Gel formation occurs under coating layer even at low concentration level when the temperature is cooled just after the coating point. The invention provides a material with good adhesion properties on polymeric web film support, including gel sub layers, and avoids the use of crosslinkers such as borax, dihydroxy dioxane, and aldehyde. The change in the setting properties can be controlled by varying the concentration in carrageenan and by playing on the ratio between polyvinyl alcohol and carrageenan.

The porous absorbent coating of the hydrophilic receiving layer contains a gelator capable of forming a thermoreversible gel. The gelator is a preferably a hydrophilic polysaccharide. Carrageenan, the preferred polysaccharide, acts as a gelating agent enabling thermoreversible gelation of the composition intended to form the porous absorbent coating of the receiving layer. Carrageenan may be derived from dried extracts of red seaweed (rhodophyceae). Carrageenans are linear polysaccharides made up of more or less substituted galactose units. The chain is made up of subunits called carrabioses comprising two galactose units bound by a β(1-4) linkage. These carrabioses are bound together in the chain by α(1-3) linkages. Furthermore, the galactose units are either esterified by sulfuric acid, or have an oxygen bridge between carbons 3 and 6. Carrageenans are polymers made up of more than 1000 galactose residues (units). There are three main types of carrabiose: κ-carrabiose, ι-carrabiose, and λ-carrabiose, corresponding to the three main types of κ-carrageenans, a polysaccharide made up of n units of κ-carrabiose, ι-carrageenan, a polysaccharide made up of n units of ι-carrabiose, and λ-carrageenan, a polysaccharide made up of n units of λ-carrabiose. In one embodiment of the invention, the first component is a carrageenan compound exhibiting preferably a low Kappa fraction and a high iota fraction in combination with, as a second component, guar gum, a third component of polyvinyl alcohol and a fluorinated compound.

This gelling agent is a carrageenan product exhibiting preferably an iota fraction varying from 100 to 70% and a kappa fraction varying from 0 to 30% to achieve gel formation for low concentration level. In the wet coating composition, the gelling agent has a concentration of less than 1% in weight, more preferably a concentration of from 0.1 to 1.0% in weight, most preferably from 0.1 to 0.2% in weight content.

The porous absorbent coating of the receiving layer also contains polymeric binders. Most preferred are polymeric materials exhibiting hydrogen bonding properties containing hydroxyl groups. One most preferred material is guar gum. Guar gum acts to control carrageenan helix aggregation. The guar gum is used in the range of 1/20 to ⅕ of the carrageenan content and more preferably equal to 1/10 of the carrageenan weight content.

According to the invention, the ink-receiving layer comprises at least one polymer comprising hydroxyl groups. The polymer is most desirably water soluble and/or hydrophilic. Preferably, the polymer comprising the hydroxyl groups is selected from among the group including polyvinyl alcohol and guar gum, or a mixture of these polymers. The polymer comprising the hydroxyl groups enables the syneresis phenomena to be controlled to form a film as a gel without crystallization phenomena, even after the drying phase.

Another preferred binder is polyvinyl alcohol exhibiting an averaged molecular weight in the range of 55,000 to 200,000 g/mole and more preferably an averaged molecular weight greater than 90,000 g/mole. The use of polyvinyl alcohol increases the gel strength, reducing syneresis phenomena, especially in synergy with guar gum, promoting good mechanical properties (adhesion, cracking) and gloss.

The porous absorbent coating of the receiving layer also contains a nonionic fluorinated compound exhibiting the ability to interact with carrageenan iota to produce stronger gel formation in order to achieve good chill setting properties to provide good coating quality. The fluorinated polyether surfactant is a preferred chemical structure. The concentration of the fluorinated surfactant can vary in the range of from 0.2 to 2% in weight content of the active compound. The ratio between polyvinyl alcohol and fluorinated compound in weight content might be in the range of from 1:1 to 15:1 and more preferably in the range of from 1:1 to 8:1.

The aqueous-based porous absorbent coating of the receiving layer can contain other additives such as surfactants (preferably nonionic fluorinated) or other materials for creating imaging or receiving layers. The coating thickness is typically in the range of 10 to 50 μm (dried thickness) and preferably about 25 μm.

The aqueous-based porous absorbent coating of the receiving layer contains inorganic porous material and with a low hydrophilic polymers content between 1% to 15% in weight, more preferably 2 to 10% in weight from the combination of gelator material (carrageenan iota) and two hydroxylated polymers (polyvinyl alcohol, guar gum). The weight ratio between hydroxylated polymers (polyvinyl alcohol, guar gum) and gelator is varying in the range of 4:1 to 40:1, more preferably 10:1 to 30:1.

The polysaccharide/polyvinyl alcohol binder system with fluorinated compound and inorganic porous material offers good mechanical properties: no curl propensity (guar gum combined with carrageenan), good adhesion (no cracking propensity) observed onto the raw support resin coated paper (no gelatin sublayer required) having a corona treatment in line just before coating of the inkjet receiving layer. This system provides good printing performance, including ink drying fastness, no ink coalescence or spreading for various inkjet printers and good image stability.

The invention provides material exhibiting good adhesion properties on polymeric web film support, including the gel sub layer, and avoids the use of crosslinkers such as borax, dihydroxy dioxane, and aldehyde. The change in the setting properties can be controlled by varying the concentration in Carrageenan and by playing on the fluorinated derivative content and/or the ratio between polyvinyl alcohol and fluorinated derivative. Even at the lowest level content of polyvinyl alcohol, guar gum and carrageenan, a gelled film is formed just after the coating point on the web support, even for thick layers (200 μm to 400 μm for wet thickness).

The following examples are provided to illustrate the invention.

In all examples, the components used in inkjet melt formula are expressed in weight percentage unless otherwise specified. Surfactant zonyl FSN was supplied from Dupont as 40% weight content aqueous solution. The main silica material used for the invention was Nalco 2329 used as a raw material dispersion. The main characteristics of the product are summarized in Table 1.

TABLE 1
NALCO 2329 features

| Product | Nalco 2329 |
|---|---|
| Particle Size (nm) | 75 |
| Surface Area (M²/gm) | 40 |
| % Silica (as SiO₂) | 40 |
| pH (@25° C.) | 8.4 |
| Specific Gravity | 1.29 |
| Viscosity (Centipoise) | 10 |
| Stabilizing Ion | Sodium |
| Approx. Na₂O, % | 0.30 |
| Surface Charge | Negative |
| Features | Largest Particle |

### EXAMPLE 1

### NALCO Silica 13%/PVA

NALCO 2329 supplied by NALCO was used as the inorganic porous material. Polyvinyl alcohol was used as the binder in an aqueous mother solution with 9% PVA weight content. Polyvinyl alcohol was supplied by Nippon Goshei as Gohsenol GH-23. Surfactant 10 G was supplied from Olin as 20% weight content aqueous solution.

The mixture of inorganic material with polyvinyl alcohol was prepared by mixing vigourously and heating at 60° C. These components were added in the following order to prepare 100 g of melt:

| | |
|---|---|
| Deionized water = | 50 g |
| NALCO 2329 = | 35 g |
| GH23 = | 19 g |
| 10G = | 1.5 g |

The concentrations in weight % are reported in Table 2.

TABLE 2
% in weight content on check melt

| Components | Weight (g) | % active* | % weight** | % of solids*** |
|---|---|---|---|---|
| NALCO 2329 | 35.00 | 40.00 | 13.270 | 89.12 |
| GH-23 (sol 9%) | 19.00 | 9.00 | 1.621 | 10.88 |
| Olin 10G | 1.50 | 20.00 | 0.284 | 1.91 |
| Water (g) | 50.00 | | | |
| Total wt. (g) | 105.50 | | | |
| % solids | | | 14.891 | 100.0 |

*% of active component in the mother solution
**weight of active component into the melt
***content in % of dried active component (excluding water)

The check melt exhibited low viscosity and no gel formation was observed when the mixture was cooled below room temperature (10 to 15° C.). Furthermore, various melt replicates have been done to examine batch to batch the gloss variability of the inkjet melt coating.

The inkjet melts were coated using hand-coater equipment for a theoretical wet thickness about 200 μm on resin coated paper having a gel sub-layer coated with about 30 mg/ft2 of gelatin applied. The operating conditions are summarized in Table 3.

TABLE 3
Operating conditions for hand-coater

| Parameters | Values | |
|---|---|---|
| Coating speed | 0.3 | ms⁻¹ |
| Wet thickness | 200 | μm |
| Coated surface area | 630 | cm² |
| Web temperature | 15° | C. |
| Coated solution volume | 20 | ml |
| Melt solution temperature | 50° | C. |

The characteristics of the inkjet melts containing NALCO 2329 content in the range of 13% are summarized in Table 4. The viscosity measurements were carried out at 50° C. using Visco Star-L equipment supplied by Fungilab S.A. The determination of gloss from the coated samples was measured using Picogloss model 560 equipment from Erichsen Testing Equipment.

TABLE 4
Solution and coating features versus Pural 200 content.

| | | Viscosity* | | |
|---|---|---|---|---|
| | Solution/Gel | (mPa · s⁻¹) | Coating features | Gloss (60°) |
| Ex-1A | Homogeneous solution, | 10 | Heterogeneous coating | 50 |
| | no gel formation | | based on particle settling | |
| | | | and flow after coating | |
| Ex-1B | Homogeneous solution, | 10 | Heterogeneous coating | 24 |
| | no gel formation | | based on particle settling | |
| | | | and flow after coating | |
| EX-1C | Homogeneous solution, | 10 | Heterogeneous coating | 2 |
| | no gel formation | | based on particle settling | |
| | | | and flow after coating | |

*spindle L1, 100 rpm shear rate

The experiment 1B was performed with the same batch as example 1-A after 6 months ageing. The experiment 1C was carried out on an other batch from 1A and 1B. These three examples illustrated the large variability in terms of gloss observed from the ageing of the NALCO 2329 solution or from batch to batch process variability (propensity of particle aggregation). To conclude, the dispersion of NALCO 2329 in aqueous polyvinyl alcohol provides an unstable inkjet melt with a large propensity for particle settling. Poor coating quality was achieved due to flow after coating based on melt viscosity. After drying, the coated layer exhibited poor mechanical properties, in terms of adhesion, high cracking propensity. The inability to chill set the coated layer, as a result of no gel formation, induced high mottle levels.

The printing properties were analyzed from printed chart tests for two inkjet printers HP Deskjet 5550 and EPSON stylus Photo 890. The printing properties were evaluated for image sharpness (ink: coalescence, spray and bleed; banding, bronzing), instant dryness and abrasion sensitivity. All printing features of the coating set are reported in Table 5.

Instant dryness (Inst.Dryn.): test was done from printed test chart. Ater printing, a paper receiving sheet (A4 format, 80 g quality) was directly put onto the printed sheet and a roller (weight=2 kg, L=18.5 cm, φ=4.0 cm) was applied. The level of dye report onto the receiving sheet was qualitatively appreciated (1=no report, 2=light colored marks unability to detect pictures elements, 3=at least two identified colors and partially pictures elements, 4=at least 3 colors identified and 60-70% elements scenes reproduced on the receiving sheet, 5=all colors identified and at least 80% elements scene reproduced on the receiving sheet.

Sharpness: image sharpness was expressed from three levels (High=perfect elements scene reproduction, medium=slight image degradation based on bleed phenomena (low to medium magnitude) or coalescence (Low to high), Low=high image degradation due to muddy colors (high bleed phenomena, high spray phenomena).

Defect: recorded image degradation phenomena (A=abrasion induced by printer under marks phenomena or partial delamination, Ba=banding inducing distinct differences of pattern instead of smooth colors transition), B1=Bleed corresponding to ink spreading, C=ink coalescence, with three magnitude levels (high, Medium, Low)

TABLE 5
Printing properties of NALCO 2329 from aqueous PVA solution

| | HP 5550 | | | EPSON 890 | | |
|---|---|---|---|---|---|---|
| | Inst. | Imag. | | Inst. | Imag. | |
| Experiments | Dryn | Sharp. | Defect | Dryn. | Sharp. | Defect |
| Ex-1A | 3 | Medium | Ba(M) | 5 | Poor | Ba(H) |
| | | | C(M) | | | Bl(H) |
| | | | | | | C(H) |
| Ex-1B | 3 | Medium | Ba(M) | 5 | Poor | Ba(H) |
| | | | C(M) | | | Bl(H) |
| | | | | | | C(H) |
| Ex-1C | 3 | Medium | Ba(M)) | 5 | Poor | Ba(H) |
| | | | C(M) | | | Bl(H) |
| | | | | | | C(H) |

For both image printers, poor image quality was achieved based on a high propensity for ink coalescence and poor instant dryness properties of the receiver.

The image stability was evaluated for light and ozone impact for HP5550 printer. Only light impact was documented for the EPSON printer. The printed densities were measured on Spectrolino equipment. For both light and ozone testing, the studies were done on maximum density for cyan (C), magenta (M), yellow (Y) and black (K) dyes. The lightfastness testing was performed for 50 kLux and 2 weeks duration. The results are expressed in % Dmax density loss.
Dmax density lost %=[(d_{L}−d₀)/d₀]*100
With d₀=intitial measured density
d_{L}=density measured after 2 weeks under light exposure

The ozone fastness testing was carried out under 60 ppb ozone in dark room chamber for 3 weeks duration. The results are expressed in % Dmax density loss.
Dmax density lost %=[(d_{oz}−d₀)/d₀]*100
With d₀=intitial measured density
d₀=density measured after 3 weeks ozone exposure

All results in terms of light and ozone testing are reported in Table 6 and expressed in % density lost. The dye density loss goal is less than 30% loss for both ozone or lightfastness.

TABLE 6
Light and ozone fastness for both printer systems

| | HP 5550 | | EPSON 890 | |
|---|---|---|---|---|
| Experiment | Light | Ozone | Light | Ozone |
| Ex-1A | C = 19.1 M = 6.5 | C = 47.5 M = 69.6 | C = 4.5 M = 25.6 | C = 16.5 M = 36.8 |
| | Y = 2.5 K = 10.2 | Y = 6.8 K = 51.6 | Y = 4.7 K = 21.1 | Y = 6.1 K = 25.8 |

The light stability for both printer systems was relatively good. The dye loss recorded for all colors were less than 30% of the initial Dmax values. However, the image stability of prints was drastically affected by ozone exposure for both printer systems with high dye loss above the recommended threshold of 30%.

### EXAMPLE 2

### Polvsaccharides/PVA Systems

1-Impact of Carrageenan Type:

The main types of carrageenan are differentiated as a function of the sulphate group substituting the galactose unit: Kappa exhibits 1 sulphate for 2 galactose units, 1 sulphate per galactose unit for iota, 3 sulphates for 2 galactose units for Lambda. The carrageenan Kappa and Iota are capable of forming gels. Carrageenan Lambda was considered a thickener.

From preliminary screening, carrageenan lambda was discarded from this application based on the unability to obtain hydrogel formation. The experiments were pursued using carrageenan kappa, iota and the mixture kappa/iota). The samples were supplied by Degussa Texturant Systems (France). All compounds were used without any purification treatment. The various salt contents are indicated in Table 7 (information provided by Degussa Texturant Systems) for carrageenan exhibiting a high Kappa fraction.

TABLE 7
Salts content in carraghenanes

| Compounds | Na⁺ | K⁺ | Ca²⁺ |
|---|---|---|---|
| ME-5 | 1.4 | 14.4 | 0.1 |
| AMP-45 | 1 | 7 | 0.4 |
| SIA | — | — | — |

Salts content: expressed in g/100 g of considered carrageenan compound.

The carrageenans kappa and iota cannot be supplied as pure compounds. Generally, their extracts contained a large majority fraction of the specified form [A. Parker et Al., Carbohydrate Polymers, 20 (1993), 253-62]. The iota fraction was determined using IR spectroscopy and measurements were performed at 805 cm⁻¹ (pronounced band attributed to 3,6-anhydro-D-galactose 2-sulfate) [D. A. Rees, Advances in Carbohydrate Chemistry (1969), 24 267-332]. The calibration was carried out on powder samples by mixing both pure kappa (ME5) and pure iota (SIA): The iota weight ratio varied from 0 to 20% maximum. The calibration measurements are reported in Table 8.

TABLE 8
Determination Kappa/Iota ratio in carrageenans

| Carraghenane | Kappa | Kappa | iota | iota |
|---|---|---|---|---|
| type weight ratio | (calib) | (pred) | (calib) | (pred) |
| SIA (Iota) | 0 | −0.30 | 100 | 100.30 |
| ME5 (Kappa) | 100 | 99.32 | 0 | 0.68 |
| ME5 80 (Kappa)/SIA 20 (Iota) | 80 | 82.00 | 20 | 18.00 |
| ME5 90 (Kappa)/SIA 10 (Iota) | 90 | 90.20 | 10 | 9.80 |
| ME5 95 (Kappa)/SIA 5 (Iota) | 95 | 93.78 | 5 | 6.22 |
| AMP 45 (Kappa/Iota) | | 94.86 | | 5.14 |

The iota content in the AMP45 and in the ME5 samples was determined. Other compounds supplied by Degussa Texturant systems were guar gum (viscogum BCR 13/80) and Xanthan gum (Satiaxane CX90) compounds. Guar gum is well known to interact with carrageenans (κ and ι fraction) to promote helix aggregation and control syneresis phenomena.

2- Potassium Content & Carrageenan Iota

To boost the gelling power of Kappa/iota carrageenan, the addition of potassium ion was recommended based on the ability of potassium to diffuse into the helix to counterbalance the negative charge of the sulfate group and inducing helix aggregation to promote higher gel formation. Generally, the potassium salt content correspond to 1/10^{th} of the carrageenan content in weight. Nevertheless, the addition of potassium salt (chloride form) did not impact the printing properties or image fastness (light and ozone).

3- Coating of the Various Polysaccharide Systems and Checks

A-Preparation of the Mother Solutions

All the solutions were prepared using deionized water. The polyvinyl alcohol was supplied by Gohsenol as GH23 (hydrolysis rate 87-89%). The concentration of all required solutions are reported in Table 9. Each solution was prepared using similar operating conditions. Each compound was added into the required water volume at room temperature under magnetic stirring, avoiding vortex formation. After 1 hour, the mixture was heated at 80° C. until complete material dissolution. After dissolution, the solution was cooled at room and water was added to overcome evaporation. All polysaccharides solutions were stored at 8° C. to avoid biogrowth.

TABLE 9
Content of the various mother solutions

| | PVA | | | | | |
|---|---|---|---|---|---|---|
| Compounds | GH 23 | ME5 | AMP45 | CX90 | SIA | Viscogum |
| GH 23 (g) | 180 | 0 | 0 | 0 | 0 | 0 |
| ME5 (g) | 0 | 30 | 0 | 0 | 0 | 0 |
| AMP45 (g) | 0 | 0 | 30 | 0 | 0 | 0 |
| SIA (g) | 0 | 0 | 0 | 0 | 30 | 0 |
| CX90 (g) | 0 | 0 | 0 | 10 | 0 | 0 |
| Viscogum | 0 | 0 | 0 | 0 | 0 | 2 |
| (g) | | | | | | |
| Water | 1820 | 970 | 970 | 990 | 970 | 198 |
| QSP | 2000 | 1000 | 1000 | 1000 | 1000 | 200 |
| % solid | 9.00% | 3.00% | 3.00% | 1.00% | 3.00% | 1.00% |

B-Preparation of the Polysaccharides Inkjet Melts

The comparison of the various polysaccharides systems was carried out for combinations of carrageenan/guar gum and carrageenan/PVA.

ME5/Viscogum

23.5 g of ME5 solution (3% content) was added in 68 ml of deionized water under magnetic stirring and heated at 60° C. The required amount of viscogum (7 g, 1% solution content) was added and the mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

ME5/PVA

23.5 g of ME5 solution (3% content) was added in 59 ml of deionized water under magnetic stirring and heated at 60° C. The required amount of PVA (16.5 g, 9% solution content) was added and the mixture was stirred for 30 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

AMP45/Viscogum

23.5 g of AMP45 solution (3% content) was added in 62 ml of deionized water under magnetic stirring and heated at 60° C. The required amount of viscogum (7 g, 1% solution content) was added and the mixture was stirred for 15 min., after which, potassium chloride solution was added (7 g, 1% solution content). To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

AMP45/PVA

23.5 g of AMP45 solution (3% content) was added in 51 ml deionized water under magnetic stirring and heated at 60° C. The required amount of PVA (16.5 g, 9% solution content) was added and the mixture was stirred for 30 min., after which, potassium chloride solution was added (7 g, 1% solution content). To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

SIA/Viscogum 23.5 g of SIA solution (3% content) was added in 68 ml of deionized water under magnetic stirring and heated at 60° C. The required amount of viscogum (7 g, 1% solution content) was added and the mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

SIA/PVA

23.5 g of AMP45 solution (3% content) was added in 58 ml of deionized water under magnetic stirring and heated at 60° C. The required amount of PVA (16.5 g, 9% solution content) was added and the mixture was stirred for 30 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

C-Prepartion of Check Inkjet Melts

The previous polysaccharides systems were compared with PVA or viscogum alone or PVA with viscogum in combination.

PVA

33.33 g of PVA solution (9% solution content in GH23) was added in 65 ml of deionized water under magnetic stirring and heated at 60° C. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

Viscogum

70 g of viscogum (1% content) was added in 29 ml of deionized water under magnetic stirring and heated at 60° C. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

Viscogum/PVA

70 g of viscogum solution (1% content) was added in 29 ml of deionized water under magnetic stirring and heated at 60° C. The required amount of PVA GH23 (16.5 g, 9% solution content) was added and the mixture was stirred for 15 min. To improve coating homogeneity, 10 G surfactant (1.5 g, 20% solution content) was introduced under smooth stirring to avoid foam formation. The mixture was cooled at room temperature and the required amount of deionized water was added to obtain 100 g of mixture.

D-Coating of the Inkjet Melts

All inkjet melts were coated using a hand coater for a theoretical wet thickness of about 200 μm on resin coated paper having gel sub-layer coated with about 30 mg/ft2 of gelatin applied using corona treatment in line. The operating conditions are summarized in Table 10.

TABLE 10
Operating conditions for hand-coater

| Parameters | Values | |
|---|---|---|
| Coating speed | 0.3 | ms⁻¹ |
| Wet thickness | 200 | μm |
| Coated surface area | 630 | cm² |
| Web temperature | 15° | C. |
| Coated solution volume | 20 | ml |
| Melt solution temperature | 60° | C. |

The solution and coating features for all experiments are reported in Table 11. The viscosity measurements were carried out at 60° C. (L2 spindle, with 100-200 rpm shear rate) using Visco Star-L equipment supplied by Fungilab S.A. The determination of gloss from the coated samples was measured using Picogloss model 560 equipment from Erichsen Testing Equipment.

All polysaccharides systems in combination with guar gum or PVA exhibited high coatability with good homogeneity and good mechanical properties (good adhesion to support, no cracking propensity). The good coating homogeneity can directly connected to the ability to achieve easy gel formation for all polysaccharides systems, based on combination with PVA or guar gum. Polyvinyl alcohol, when used alone as the film former, exhibited no chill setting properties and cannot provide, by itself, a homogeneous coating thickness and insensitivity to abrasion.

Guar gum used alone acted as a thickener, providing homogeneous coatings with good mechanical properties. The association of polyvinyl alcohol with guar gum provided an unstable solution when the mixture was cooled to room temperature. A fast demixing phenomena was observed, with an upper transparent phase (PVA) and an opalescent bottom phase (guar gum).

Polyvinyl alcohol provided higher gloss levels. For carrageenans compounds, the higher gloss level was achieved in combination with polyvinyl alcohol. Lower levels were obtained by combination with guar gum. The higher the iota fraction, the higher the gloss level.

The polyvinyl alcohol alone did not provide very homogeneous coatings, even when the coated sample was fully dried. PVA coatings can be achieved only with hand-coating equipment, not with a coating machine using a vertical loop dryer.

The printing properties were analyzed for printed chart tests for two inkjet printers HP Deskjet 5550 and EPSON stylus Photo 890. The printing properties are evaluated for image sharpness (ink: coalescence, spray and bleed; banding, bronzing), instant dryness and abrasion sensitivity. All printing features of the coating set are reported in Table 12.

The experimental series demonstrated that only carrageenan kappa or kappa/iota or iota in combination with hydroxylated polymers provided inkjet media with high/medium image sharpness as a function of the printer type, good instant dryness characteristic, notably for association with polyvinyl alcohol. Furthermore, polysaccharides associated with hydroxylated polymers provided good mechanical properties: high adhesion onto resin coated paper, no cracking propensity, no curl sensitivity. For the EPSON printer, a degradation of the image quality resulting from ink coalescence or bleeding phenomena was related to a larger ink volume delivered, as compared to the HP printer, which delivers a more concentrated ink.

TABLE 11
Solution & coating features from inkjet melts

| | | | Viscosity | | Gloss |
|---|---|---|---|---|---|
| Polysaccharide | Co-binder | Solution/Gel | (mPa · s⁻¹) | Coating features | (60°) |
| ME5 | Viscogum | Homogeneous & | 10 | Homogeneous coating, | 26 |
| | | opalescent, strong gel, | | fast setting property, | |
| | | 3% syneresis | | good adhesion | |
| | PVA | Homogeneous & | 17 | Homogeneous coating, | 32 |
| | | transparentent, strong | | fast setting property, | |
| | | gel, 2% syneresis | | good adhesion | |
| AMP45 | Viscogum | Homogeneous & | 17 | Homogeneous coating, | 30 |
| | | opalescent, strong gel, | | fast setting property, | |
| | | 3% syneresis | | good adhesion | |
| | PVA | Homogeneous & | 30 | Homogeneous coating, | 40 |
| | | transparent, strong gel, | | fast setting property, | |
| | | 1% syneresis | | good adhesion | |
| SIA | Viscogum | Homogeneous & | 31 | Homogeneous coating, | 35 |
| | | transparent, soft gel | | fast setting property, | |
| | | | | good adhesion | |
| | PVA | Homogeneous & | 39 | Homogeneous coating, | 55 |
| | | transparent, soft gel | | fast setting property, | |
| | | | | good adhesion | |
| PVA | 0 | Homogeneous | 6.6 | Unhomogeneous | 88 |
| | | tranparent solution | | coating thickness, | |
| | | | | abrasion sensitivity | |
| Viscogum | 0 | Homogeneous | 40 | Homogeneous coating, | 55 |
| | | | | unsetting, good | |
| | | | | adhesion | |
| | PVA | Demixing, transparent | 13 | Homogeneous coating, | 55 |
| | | top phase, bottom | | unsetting, poor | |
| | | opalescent phase | | adhesion, cracked | |
| | | | | surface | |

TABLE 12
Printing properties of polysaccharides systems

| | | Priting properties | | | | | | | |
|---|---|---|---|---|---|---|---|---|---|
| | | HP 5550 | | | | EPSON 890 | | | |
| Binder systems | | Inst. | Imag. | | Fing. | Inst. | Imag. | | Fing. |
| Polysaccharide | Co-binder | Dryn. | Sharp. | Defect | sens | Dryn. | Sharp. | Defect | sens. |
| ME5 | Viscogum | 3 | Medium | S(L) | No | 5 | Low | S(H), | No |
| | | | | | | | | Bl(H) | |
| | PVA | 1 | High | No | No | 2 | Medium | C(H), | No |
| | | | | | | | | Ba(H) | |
| AMP45 | Viscogum | 2 | High | No | No | 4 | Low | C(H), | No |
| | | | | | | | | Bl(H) | |
| | PVA | 1 | High | No | No | 2 | Medium | C(H), | No |
| | | | | | | | | Ba(H) | |
| SIA | Viscogum | 5 | Medium | S(M), | No | 5 | Low | S(H), | No |
| | | | | Bl(M) | | | | Bl(H), | |
| | | | | | | | | Ba(H) | |
| | PVA | 3 | High | No | No | 3 | Medium | C(H), | No |
| | | | | | | | | Ba(H) | |
| PVA | 1.50% | 5 | High | No | Yes | 5 | Low | C(L), | Yes |
| | | | | | | | | Bl(H), | |
| | | | | | | | | S(H), | |
| | | | | | | | | Ba(L) | |
| | 3% | 3 | High | No | Yes | 5 | Medium | C(H), | Yes |
| | | | | | | | | Bl(H), | |
| | | | | | | | | Ba(H), | |
| | | | | | | | | A(M) | |
| Viscogum | 0 | 5 | Medium | C(M) | Yes | 5 | Low | C(H) | Yes |
| | | | | A(M) | | | | Bl(H) | |
| | | | | Bl(L) | | | | S(H) | |
| | | | | | | | | Ba(H) | |
| | PVA | 2 | High | Bl(L) | No | 4 | Low | Bl(H) | No |
| | | | | A(H) | | | | Ba(H) | |
| | | | | | | | | A(H) | |
| Rc Paper | 0 | 5 | No image | C(H), | Yes | 5 | No image | Bl(H), | Yes |
| | | | | Bl(H) | | | | S(H), | |
| | | | | | | | | C(H) | |

The image stability was evaluated for light and ozone impact for HP5550 printer. Only light impact was documented for the EPSON printer. The printed densities were measured on Spectrolino equipment. For both light and ozone testing, the studies are done on maximum density for cyan (C), magenta (M), yellow (Y) and black (K) dyes. The light fastness testing was performed for 50 kLux and 2 weeks duration. The results were expressed in % Dmax density loss.

All results in terms of light and ozone testing are reported in Table 13 and expressed in % density lost. A dye density loss of less than 30% for both ozone or light fastness was desired.

TABLE 13
Lightfastness & ozonefastness

| Systems | | HP5550 | | EPSON 890 |
|---|---|---|---|---|
| Polysaccharide | Co-binder | Light | Ozone | Light |
| ME5 | Viscogum | C = 10.4 M = 16.2 | C = 0.0 M = 16.9 | C = 3.9 M = 29.1 |
| | | Y = 8.6 K = 15.9 | Y = 8.5 K = 11.1 | Y = 6.8 K = 22.5 |
| | PVA | C = 12.9 M = 5.2 | C = 0.0 M = 0.0 | C = 5.1 M = 14.0 |
| | | Y = 6.3 K = 3.0 | Y = 2.8 K = 0.0 | Y = 0.3 K = 8.9 |
| AMP45 | Viscogum | C = 10.3 M = 17.6 | C = 4.7 M = 22.3 | C = 8.0 M = 44.1 |
| | | Y = 11.5 K = 18.4 | Y = 17.4 K = 18.8 | Y = 7.4 K = 23.7 |
| | PVA | C = 6.4 M = 2.8 | C = 0.0 M = 0.0 | C = 0.0 M = 9.1 |
| | | Y = 5.5 K = 2.5 | Y = 9.8 K = 0.0 | Y = 0.0 K = 5.7 |
| SIA | Viscogum | C = 33.0 M = 28.3 | C = 22.9 M = 12.4 | C = 11.5 M = 75.5 |
| | | Y = 17.9 K = 20.9 | Y = 0.5 K = 11.8 | Y = 14.7 K = 32.4 |
| | PVA | C = 6.0 M = 1.4 | C = 0.0 M = 0.0 | C = 0.0 M = 19.0 |
| | | Y = 4.6 K = 1.4 | Y = 0.0 K = 0.0 | Y = 0 K = 4.9 |
| PVA | 0 | C = 25.3 M = 4.9 | C = 15.2 M = 5.4 | C = 0.0 M = 30.7 |
| | | Y = 9.1 K = 4.6 | Y = 4.1 K = 2.3 | Y = 0.0 K = 4.2 |
| Viscogum | 0 | C = 35.3 M = 37.0 | C = 0.0 M = 19.3 | C = 7.3 M = 56.5 |
| | | Y = 18.5 K = 13.5 | Y = 8.9 K = 11.6 | Y = 15.2 K = 35.3 |
| | PVA | C = 16.8 M = 43.6 | C = 15.1 M = 10.1 | C = 16.8 M = 43.6 |
| | | Y = 2.9 K = 10.9 | Y = 1.8 K = 5.7 | Y = 2.9 K = 10.9 |

Carrageenans materials combined with polyvinyl alcohol provided stronger image stability to light and ozone exposure, compared to carrageenan materials combined with guar gum or to comparative checks.

### EXAMPLE 3

### NALCO 2329 and Carrageenan Kappa Versus Iota or Combination

The preliminary screening phase investigated the interactions between silica material and carrageenan materials to determine the most appropriate carrageenan type to achieve good binder properties and a homogeneous coating through chill setting.

The experimental set was performed with NALCO 2329 as the inorganic pigment with relatively high particles content and the three carrageenan types (Kappa as Satiagel ME5, Kappa/iota as Satiagel AMP45, iota as Satiagel SIA) at equivalent level. The melt compositions are indicated in Table 14.

TABLE 14
Inkjet melt composition

| Components | Weight (g) | % content | % active | % of solids |
|---|---|---|---|---|
| NALCO 2329 | 88.00 | 40.00 | 35.200 | 99.00 |
| Carrageenan (gel 3%) | 1.67 | 3.00 | 0.050 | 0.14 |
| viscogum (gel 1%) | 0.50 | 1.00 | 0.005 | 0.01 |
| GH-23 (sol 9%) | 3.33 | 9.00 | 0.300 | 0.84 |
| g solids | 35.55 | | | 100.00 |
| Water (g) | 6.50 | | | |
| total wt. | 100.00 | | | |

The NALCO 2329 dispersion was heated with the water at 60° C. The carrageenan and guar gum (viscogum) were mixed together under magnetic stirring and heated at 60° C. The polysaccharides mixture was introduced in the NALCO 2329 aqueous dispersion under efficient stirring and the heating was maintained at 60° C. for 30 minutes. After this waiting period, the polyvinyl alcohol was added to the mixture. After the polyvinyl alcohol addition, water was added to compensate the water evaporation. For carrageenans kappa/iota (AMP45) and iota (SIA), a potassium chloride addition was carried out (0.05% in weight of the melt).

The melt characteristics were studied by measuring the melt viscosity and examining the melt homogeneity at 60° C. and after one night of cooled storage at 4° C. The main observations are reported in Table 15.

TABLE 15
Inkjet melt features

| | | Viscosity | | | |
|---|---|---|---|---|---|
| Experiment | Carrageenan | (mPa · s) | Solution | Syneresis* | Comments |
| 3-A | ME5 (Kappa) | 15 | Demixing | 90% | Heterogeneous melt based on |
| | | | | | undissolved carrageenan |
| 3-B | AMP45 | 2300 | Thick | 10% | Reduced syneresis, too |
| | (Kappa/iota) | | | | viscous mixture |
| 3-C | SIA (iota) | 405 | Thick | 5% | Reduced syneresis |
| | | | | | homogeneous melt even the |
| | | | | | viscosity |

Syneresis: expressed in % of rejected liquid volume from gel formation after cooling phase at 4° C.

At this medium temperature, the carrageenan-k cannot be dispersed efficiently into the inkjet melt and a biphasic system was observed after stopping the magnetic stirring (upper phase 90% in volume containing a low fraction of silica particles, bottom phase representing 10% in volume containing a majority fraction of the silica particles).

For carrageenan-κ/ι (AMP45), a drastic increase in the melt viscosity was observed just after the addition of potassium chloride. This demonstrated that the salt addition was not required to achieve gel formation. In fact, there was sufficient salt content from NALCO 2329 to induce gel formation.

For carrageenan-ι (SIA), the trend observed with the carrageenan-κ/ι was similar in terms of melt viscosity in a lower magnitude (405 vs 2300 mPa·s). The addition of potassium chloride was discontinued for other experiments.

### EXAMPLE 4

### SIA Content Series

The method described in example 3 was applied, excepting the addition of the potassium chloride. To achieve good coating quality by improving melt wettability, the surfactant OLIN 10 G was added to the melt series. The melt composition is described in Table 16.

TABLE 16
Inkjet melt formulated with Satiagel SIA

| Components | Weight (g) | % content | % active | % of solids |
|---|---|---|---|---|
| NALCO 2329 | 88.00 | 40.00 | 35.200 | 97.90 |
| SIA (gel 3%) | 1.67 | 3.00 | 0.050 | 0.14 |
| viscogum (gel 1%) | 0.50 | 1.00 | 0.005 | 0.01 |
| GH-23 (sol 9%) | 3.33 | 9.00 | 0.300 | 0.83 |
| OLIN 10G | 2.00 | 20.00 | 0.400 | 1.11 |
| g solids | 35.55 | | | 100.00 |
| Water (g) | 4.50 | | | |
| total wt. | 100.00 | | | |

For this experimental series, the level of Satiagel SIA was varied from 0.05% to 0.105% in weight content. As in the previous experiments, the melt features (homogeneity, syneresis, viscosity) were documented and a coatability study on coating machine was performed. The inkjet melts were coated on a coating machine equipped with bead-coater onto resin coated paper with gel sublayer (coated with about 30 mg/ft² of gelatin). The coating parameters are reported in Table 17.

TABLE 17
Coating parameters used on coating machine

| Parameters | Values | |
|---|---|---|
| Hopper gap | 150 | μm |
| Coating speed | 16 | m/min |
| Melt temperature | 50° | C. |
| Web temperature | 50° | C. |
| Chill setting temperature | 4° | C. |
| Coated width | 0.105 | m |
| Wet coverage | 117 | ml/m² |

The main results from melt characteristics and coatability study are summarized in Table 18.

TABLE 18
Melt characteristics & coatability

| | SIA | Viscosity | | | |
|---|---|---|---|---|---|
| Melts | content % | mPa · s | Syneresis % | Coatability | Comments |
| 4-A | 0.05 | 15 | 5 | Good | rakelines |
| 4-B | 0.075 | 15 | 25 | Good | rakelines |
| 4-C | 0.105 | 15 | 50 | Good | rakelines |

The various melts prepared with Satiagel SIA in the range of 0.05% to 0.105% in weight content showed the ability to provide soft gel formation (after one night under cooled storage at 4° C.) from a bulk melt preparation with slight to high syneresis phenomena as a function the carrageenan-ι content in a practically linear relationship. Unlike the formulations using carrageenan-κ, the inkjet melts exhibited good homogeneity and no settling phenomena was observed with silica particles.

For coating quality, all inkjet melt exhibited good uniform wettability onto the resin coated substrate (no break-lines or rake-lines defects observed). The main defect observed was small rakelines defects on the hopper. This defect was induced by the lower gelling power of the carrageenan-ι compared to the carrageenan-κ.

### EXAMPLE 5

### Association Carrageenan-Iota and Fluorinated Surfactant

For this experiments series, the classical surfactant OLIN 10 G was replaced by the Zonyl FSN supplied by DUPONT. The melts were prepared using the previous procedure described in the example 3. The melt composition is indicated in Table 19.

TABLE 19
Melt composition

| Components | Weight (g) | % content | active weight | % of solids |
|---|---|---|---|---|
| NALCO 2329 | 88.00 | 40.00 | 35.200 | 98.93 |
| SIA (gel 3%) | 2.50 | 3.00 | 0.075 | 0.21 |
| viscogum (gel 1%) | 0.75 | 1.00 | 0.008 | 0.02 |
| GH-23 (sol 9%) | 3.33 | 9.00 | 0.300 | 0.84 |
| Zonyl FSN | 0.50 | 40.00 | 0.200 | 0.56 |
| g solids | 35.58 | | | 100.00 |
| Water (g) | 4.92 | | | |
| total wt. | 100.00 | | | |

The Zonyl FSN solution content was varied between 0.5 to 1.5% in weight of the inkjet melt content. The melt features are summarized in Table 20.

TABLE 20
Inkjet melt features

| Experiments | Zonyl FSN % | Viscosity* mPa · s |
|---|---|---|
| 5-A | 0.5 | 240 |
| 5-B | 1.0 | 660 |
| 5-C | 1.5 | 1380 |

*viscosity measurement done at 50° C.

The fluorinated surfactant had a strong impact on the melt viscosity and impacted drastically the chill setting properties. The gel formation was drastically increased and a stronger bulk gelation was achieved with Zonyl FSN compared to the one obtained with OLIN 10 G. There was strong interaction between Zonyl FSN and the polysaccharides compounds.

These inkjet melts were coated onto resin coated paper using the conditions described in example 2 (Table 10) for automatized hand-coater. The coating features and printing properties were studied for both printer HP 5550 and EPSON 890. The results are reported in Table 21.

TABLE 21
Coating features & printing properties

| | | HP 5550 | | | EPSON 890 | | |
|---|---|---|---|---|---|---|---|
| | Gloss | Inst. | Imag. | | Inst. | Imag. | |
| Experiments | 60° | Dryn. | Sharp. | Defect | Dryn. | Sharp. | Defect |
| 5-A | 15 | 1 | High | No | 1 | High | No |
| 5-B | 15 | 1 | high | No | 1 | High | No |
| 5-C | 14 | 1 | High | No | 1 | high | No |

The coated samples exhibited a satinated features, which was directly connected to the surface roughness. For EPSON 890, the main defect observed was a slight bronzing effect for skin color reproduction. Nevertheless, a good image sharpness and instant dryness were recorded for both printers compared to the checks from examples 1.

### EXAMPLE 6

### For Higher PVA Content/Variation SIA Level & Impact Viscogum

The experimental set was carried out to determine the impact of high polyvinyl alcohol (Gohsenol GH23 supplied by Nippon Goshei) and viscogum in the inkjet melt. To improve melt homogeneity, the preparation protocol previously used was slightly modified by increasing the heating (80° C. in place of 60° C.) to better incorporate the polysaccharide compounds. The melt composition is reported in Table 22 for the main variations of the studied parameters with viscosity measurements.

TABLE 22
Inkjet melt composition for main parameters

| | | | | Zonyl | Viscosity |
|---|---|---|---|---|---|
| Experiments | SIA % | Viscogum % | PVA % | FSN %* | mPa · s |
| 6-A | 0.05 | 0.005 | 1.4 | 0.5 | 150 |
| 6-B | 0.05 | 0 | 1.4 | 0.5 | 160 |
| 6-C | 0.07 | 0.007 | 1.4 | 0.5 | 170 |
| 6-D | 0.07 | 0 | 1.4 | 0.5 | 190 |

*expressed in weight % of Zonyl FSN solution.

The use of higher temperature and polyvinyl alcohol for the melt preparation improved melt homogeneity by increasing the dispersion of polysaccharides compounds and drastically reduced the final melt viscosity compared to example 5. The use of viscogum limited the viscosity increase.

These inkjet melts were coated using the previous conditions described in example 4 for the coating machine using raw resin coated paper, with no gelatin gel sublayer for promoting adhesion. The raw resin coated paper was submitted to in-line corona treatment before receiving the inkjet receiving layer deposit. The inkjet melts were diluted with water to 10% in weight content to minimize viscosity. The coating features in terms of gloss and printing properties are reported in Table 23.

The use of higher polyvinyl alcohol levels increased the gloss level but small to medium image degradations were a result of ink bleeding through or ink coalescence phenomena.

TABLE 23
Coating features and printing properties

| | | HP 5550 | | | EPSON 890 | | |
|---|---|---|---|---|---|---|---|
| Experi- | Gloss | Inst. | Imag. | De- | Inst. | Imag. | |
| ments | 60° | Dryn. | Sharp. | fect | Dryn. | Sharp. | Defect |
| 6-A | 30 | 1 | High | No | 2 | High | Ba(L) |
| 6-B | 27 | 1 | high | No | 1 | Medium | Ba(M) Bl(M) |
| | | | | | | | C(M) |
| 6-C | 27 | 1 | High | No | 2 | Medium | Ba(M) Bl(H) |
| | | | | | | | C(H) |
| 6-D | 25 | 1 | High | No | 1 | High | Ba(L) |

The image preservation from light or ozone was investigated. The main results are summarized in Table 24 for all experiments.

TABLE 24
Image preservation for HP5550 and EPSON 890 printers

| | |
|---|---|
| HP 5550 | EPSON |

| Experiments | Light | Ozone | Light | Ozone |
|---|---|---|---|---|
| 6-A | C = 2.9 | C = 6.7 | C = 0.0 | C = 2.2 |
| | M = 1.2 | M = 12.3 | M = 25.6 | M = 4.1 |
| | Y = 5.9 | Y = 1.3 | Y = 0.0 | Y = 0.0 |
| | K = 2.6 | K = 11.1 | K = 0.0 | K = 0.0 |
| 6-B | C = 2.3 | C = 7.6 | C = 0.0 | C = 3.0 |
| | M = 0.1 | M = 15.4 | M = 28.3 | M = 2.0 |
| | Y = 6.5 | Y = 0.0 | Y = 0.0 | Y = 0.0 |
| | K = 1.5 | K = 11.7 | K = 0.0 | K = 0.0 |
| 6-C | C = 3.4 | C = 6.1 | C = 0.0 | C = 0.6 |
| | M = 0.0 | M = 14.9 | M = 51.3 | M = 1.6 |
| | Y = 6.8 | Y = 0.0 | Y = 0.0 | Y = 0.0 |
| | K = 1.3 | K = 11.4 | K = 0.0 | K = 0.0 |
| 6-D | C = 3.7 | C = 6.5 | C = 0.0 | C = 0.2 |
| | M = 0.5 | M = 13.0 | M = 31.9 | M = 1.4 |
| | Y = 5.5 | Y = 0.0 | Y = 0.0 | Y = 0.0 |
| | K = 1.9 | K = 10.8 | K = 0.0 | K = 0.0 |
| 5-B | C = 3.4 | C = 23.7 | C = 0.0 | C = 6.3 |
| | M = 9.7 | M = 67.8 | M = 60.9 | M = 25.3 |
| | Y = 5.1 | Y = 5.8 | Y = 1.4 | Y = 1.9 |
| | K = 5.3 | K = 36.6 | K = 3.5 | K = 12.1 |

For HP 5550 printer, the use of high polyvinyl alcohol content (1.4% in place of 0.3% weight content) provided very good image preservation with silica material compared with the check results (EX-1A). There was no impact from the carrageenan-ι level. For lower polyvinyl alcohol weight content (EX-5 B), a degradation of the ozone fastness was recorded for magenta and black dyes. The dye loss density for these colors were above the acceptable dye loss limit of 30%.

For EPSON 890 printer, the trends for image preservation were relatively different. For light fastness, the use of high content in polyvinyl alcohol maintained good image preservation properties increased levels of the carrageenan-ι (0.07 in place of 0.05% in weight content) associated to viscogum had a strong negative impact. The dye loss density for magenta dye (EX-6 C) increased. In absence of the viscogum (EX-6 D), the magenta dye loss density was equivalent to the previous ones observed (EX-6 A and B). The reduction of polyvinyl alcohol (EX-5 B) at high Siatagel SIA content associated to viscogum induced a higher magenta dye loss density than those recorded for example 6 C. For the ozone fastness, the use of high polyvinyl alcohol content improved the image preservation by minimizing the dye loss density for magenta and black dyes. The dye loss density for low polyvinyl alcohol content (EX-5 B) was kept at an acceptable level.

### EXAMPLE 7

### Impact of PVA Content for Lower Zonyl FSN Content

The experimental set was carried out to determine the impact of polyvinyl alcohol (Gohsenol GH23 supplied by Nippon Goshei) at low surfactant content to reduce viscosity and improve gloss feature. The preparation protocol described in example 6 was used by increasing the heating temperature (80° C. in place of 60° C.) to better incorporate the polysaccharides compounds. The melt composition is reported in Table 25 for the main variation of the studied parameters with viscosity measurements.

TABLE 25
Inkjet melt composition for main parameters

| | | | | Zonyl | Viscosity |
|---|---|---|---|---|---|
| Experiments | SIA % | Viscogum % | PVA % | FSN %* | mPa · s |
| 7-A | 0.05 | 0.005 | 1.4 | 0.25 | 150 |
| 7-B | 0.05 | 0.005 | 1.0 | 0.25 | 100 |

*expressed in weight % of Zonyl FSN solution.

The inkjet melts exhibited good homogeneity without any particle aggregation.

To finalize the comparison with carrageenan-κ, two experimental checks were prepared using similar conditions as described in the EX 7-B but varying the surfactant type (0.25% in weight solution of Zonyl FSN, 1% in weight of OLIN 10 G solution). The main components of the composition are reported in Table 26.

TABLE 26
Inkjet melt composition for main parameters

| | | | | | Viscosity |
|---|---|---|---|---|---|
| Experiments | ME5 % | Viscogum % | PVA % | Surfactant | mPa · s |
| 7-C | 0.05 | 0.005 | 1.0 | Zonyl FSN | 130 |
| 7-D | 0.05 | 0.005 | 1.0 | OLIN 10G | 50 |

Unlike EX-7 A and B, the inkjet melts prepared with the Satiagel ME5 showed a lower melt homogeneity related to an increased particle aggregation propensity than their counter-part prepared with the Satiagel SIA.

These inkjet melts were coated using the previous conditions described in example 4 for coating machine using raw resin coated paper (no gelatin gel sublayer for promoting adhesion). The raw resin coated paper was submitted to in-line corona treatment before to receiving the inkjet receiving layer deposit. The inkjet melts were diluted with water at 10% in weight content to minimize viscosity. The coating features in terms of gloss and printing properties are reported in Table 27.

TABLE 27
Coating features and printing properties

| | | HP 5550 | | | EPSON 890 | | |
|---|---|---|---|---|---|---|---|
| Experi- | Gloss | Inst. | Imag. | | Inst. | Imag. | |
| ments | 60° | Dryn. | Sharp. | Defect | Dryn. | Sharp. | Defect |
| 7-A | 30 | 1 | High | No | 3 | Poor | Bl(H), |
| | | | | | | | C(H) |
| 7-B | 45 | 1 | high | No | 2 | High | No |
| 7-C | 6 | 1 | High | No | 1 | High | Ba(H) |
| 7-D | 22 | 1 | High | No | 4 | Medium | Ba(M) Bl(H) |
| | | | | | | | C(H) |

The reduction of the fluorinated surfactant directly impacted the gelation power and modified the hydrophobic/hydrophilic balance of the porous matrix. At high polyvinyl alcohol content (Ex-7 A) a degradation of the image sharpness was recorded for the EPSON printer. If the polyvinyl alcohol content (Ex-7 B) was reduced, the printing properties were practically fully restored. The use of Satiagel ME5 did not provide good gloss or image printing properties.

This experimental series confirms the benefits of the carrageenan-ι, compared to carrageenan-κ, in the preparation of homogeneous aqueous silica dispersions with high particles content. To achieve good coating quality and good mechanical properties (abrasion, adhesion), the carrageenan-ι might be associated to fluorinated surfactant and polyvinyl alcohol. This combination reinforced the gelation power of the carrageenan-ι. A trade-off in terms of polyvinyl alcohol and surfactant content might provide a glossy media with the required printing properties and image preservation.

The invention has been described in detail with particular reference to certain preferred embodiments thereof, but it will be understood that variations and modifications can be effected within the spirit and scope of the invention.

1. An image receiver element comprising a support having on at least one surface thereof a porous absorbent coating layer comprising an inorganic colloidal particulate material, having a negatively charged surface, in a binder matrix, wherein said binder matrix comprises a hydrophilic gelator, a fluorinated compound, and at least one polymer comprising hydroxyl groups.

2. The image receiver element of claim 1 wherein said hydrophilic gelator is a thermoreversible gelator.

3. The image receiver element of claim 2 wherein said hydrophilic gelator is a polysaccharide.

4. The image receiver element of claim 3 wherein said polysaccharide comprises carrageenan.

5. The image receiver element of claim 1 wherein said hydrophilic gelator is carrageenan-iota.

6. The image receiver element of claim 1 wherein said hydrophilic gelator is a carrageenan product exhibiting an iota fraction of from 100 to 70% and a kappa fraction of from 0 to 30%.

7. The image receiver element of claim 1 wherein said hydrophilic gelator is present in an amount of from 0.1 to 1.0% in weight.

8. The image receiver element of claim 1 wherein said hydrophilic gelator has a concentration level of from 0.1 to 0.2% in weight.

9. The image receiver element of claim 1 wherein said at least one polymer comprising hydroxyl groups is a mixture of guar gum and polyvinyl alcohol.

10. The image receiver element of claim 9 wherein said polyvinyl alcohol has an averaged molecular weight greater than 90,000 g/mole.

11. The image receiver element of claim 9 wherein said guar gum is present in the range of from 1/20 to ⅕ of the content of said hydrophilic gelator.

12. The image receiver element of claim 9 wherein said guar gum is present in an amount equal to 1/10 of the content of said hydrophilic gelator.

13. The image receiver element of claim 1 wherein said at least one polymer comprising hydroxyl groups is water soluble.

14. The image receiver element of claim 1 wherein said fluorinated compound is a fluorinated polyether surfactant.

15. The image receiver element of claim 1 wherein said fluorinated compound has a concentration of from 0.2 to 2% in weight content of the active compound.

16. The image receiver element of claim 1 wherein the ratio between said polyvinyl alcohol and said fluorinated compound in weight content is from 1:1 to 15:1.

17. The image receiver element of claim 1 wherein the ratio between said polyvinyl alcohol and said fluorinated compound in weight content is 1:1 to 8:1.

18. The image receiver element of claim 1 wherein the content of said hydrophilic gelator and said at least one polymer comprising hydroxyl groups is from 1% to 15% in weight.

19. The image receiver element of claim 1 wherein the content of said hydrophilic gelator and said at least one polymer comprising hydroxyl groups is from 2% to 10% in weight.

20. The image receiver element of claim 1 wherein the weight ratio between said at least on polymer comprising hydroxyl groups and said hydrophilic gelator is from 4:1 to 40:1.

21. The image receiver element of claim 1 wherein said inorganic colloidal particulate material with a negatively charged surface is silica or modified silica.

22. The image receiver element of claim 1 wherein said support comprises a raw corona treated, resin-coated paper in direct contact with said porous absorbent coating.

23. The image receiver element of claim 1 wherein said image receiving element is an inkjet receiving element for inkjet printing.

24. A receiver for inkjet printing comprising a support having on at least one surface thereof a porous absorbent coating comprising a colloidal particulate material, having a negatively charged surface, in a binder matrix, wherein said binder matrix comprises a hydrophilic gelator, guar gum, a fluorinated compound, and polyvinyl alcohol.
